(19) United States
(12) Patent Application Publication
(10) Pub. No.: US 2011/0027429 A1
(43) Pub. Date: Feb. 3, 2011

(54) EATING TOOLS, MANUFACTURING METHOD AND A MANUFACTURE APPARATUS OF THE EATING TOOLS

(76) Inventor: Hajime Kogane, Kanagawa (JP)

Correspondence Address: MAIER & MAIER, PLLC, 1000 DUKE STREET, ALEXANDRIA, VA, 22314, US

(21) Appl. No.: 12/845,959

(22) Filed: Jul. 29, 2010

(30) Foreign Application Priority Data
Jul. 31, 2009 (JP) 2009-179790

(51) Int. Cl. B65D 85/00; B29C 65/02

(52) U.S. Cl. 426/132; 426/443; 156/499

(57) ABSTRACT

Eating tools for drinking or eating food comprising a contact part for holding food and touching in a user's mouth, an additional foods part adhered or applied to additional foods which contain either seasoning, food, medicines or a nutrients in the contact part. In the additional foods part, the contact part surfaces adheres to granular or powdered addition foods by adhesive adhesion material. Thereby, favorite flavor can be eaten and various flavors can be tasted, without requiring a complicated step.

### CROSS-REFERENCE TO RELATED APPLICATION

This application is a continuation application which claims benefit of priority under 35 USC 119 based on Japanese patent application 2009-179790, filed Jul. 31, 2009, the entire contents of which are incorporated by reference herein.

### FIELD OF THE INVENTION

The present invention relates to eating tools that can be used to eat food or drink, a manufacturing method and the manufacture apparatus of the tools.

### BACKGROUND OF THE INVENTION

Conventionally, when people drink coffee, tea, they mixes sugar or syrup into them, to suit their taste. And nowadays, with the recent variegation in the taste, various kinds of seasonings are mixed. Conventionally, for eating yogurt, a pudding, ice cream, etc., simple eating tools made from a plastic or wooden, such as a spoon and a fork, are used. And there was a spoon with a pack of syrup combined in the past (for example, patent Literature 1). According to this spoon, the parts can be decreased and sweet taste can be added to food with an easy device.

Patent Literature 1: JP, 10-80350, A

### SUMMARY OF THE INVENTION

However, in the case of the spoon of the literature 1, before using it, a user had to remove a cover from the spoon. So, troublesomeness increases for the user. In case of the spoon, when the spoon was used, all the food always became the same flavor thereby mixing seasoning in food directly.

The present invention has been made in order to solve the problems as described above, and it is an object to provide eating tools, a manufacturing method, and a manufacture apparatus wherein it is possible to have a favorite taste without complicated operation.

(Means for Solving the Problem)

In order to accomplish the object as described above, the present invention provides a eating tools for drinking or eating food comprising; a contact part for holding food and touching in a user's mouth, an addition foods part adhered or applied addition foods which contain either seasoning, food, medicines or a nutrients in the contact part.

In accordance with the above inventions, a tool which touches in a mouth of users, such as a spoon or a fork is adhered a seasoning, food, a medicine, and a nutrient (for example, supplements are included) previously. Accordingly, the user does not need to mix a seasoning, and he has a favorite taste eaten, without doing complicated operations. Addition foods are mixed only in a part contacted eating tools directly. Therefore, addition foods are not mixed in food too much. So in a medical field, in cases where intake, such as sugar and salt, is restricted, the present invention is used, the intake can be restricted certainly, and the dosage can be certainly prescribed for the patient.

In the invention as described above, it is preferred that the addition foods part is made up by, coating on the surface of the contact part by a bonding material which has adhesiveness, and putting the addition foods as granular or powdered on the contact part. In this case, because the addition foods have adhered to the contact part by an adhesion material, addition foods paste on the contact part more certainly. For that reason, the addition foods do not peel off from the eating tools while in use it or before use it. If addition foods are salt, a contact part will be sterilized with the salt and it will become sanitary.

In the invention as described above, it is preferred that the addition foods part is made up by, coating on the surface of the contact part by the addition foods as liquid, and solidify the liquefied addition foods. In this case, because liquefied addition foods are solidified to eating tools, it can be manufactured easily and addition foods can be adhered more certainly. In the present invention, a spoon, a fork, a knife and chopsticks which carry food in a user's mouth, a plate, a bowl, a glass which carry food, etc. are contained as eating tools. The contact part may be removable from other component part of eating tools. About this, a spoon is explained as eating tools, for example. The spoon has a contact part for holding food and touches a user's mouth, and a handle held and operated by a hand. And in cases where a contact part is removable from a handle, the user can change to other contact part of different flavor, and can taste other tastes. Accordingly, it is economical because a material of a handle will be recyclable.

In the above invention, the contact part can be made from wood or thermoplastic resin. In this case, because addition foods can be adhered or coated to usual tableware in a market, the present invention can be used for existing goods.

Other inventions are a manufacturing method of an eating tools used for drinking or eating food comprising, a contact part for holding food and touching in a user's mouth, an addition foods part adhered or applied addition foods which contain either seasoning, food, medicines or a nutrients in the contact part, wherein the method by; (1) coating on the surface of the contact part by a bonding material which has adhesiveness, and (2) putting the addition foods as granular or powdered on the contact part.

In accordance with the above inventions, eating tools adhere to a seasoning as solids, such as sugar and salt, strongly by an adhesion material. Therefore, addition foods paste the contact part more certainly and addition foods do not peel off from eating tools while in use it or before use it.

Other inventions are a manufacturing method of an eating tools used for drinking or eating food comprising, a contact part for holding food and touching in a user's mouth, an addition foods part adhered or applied addition foods which contain either seasoning, food, medicines or a nutrients in the contact part, wherein the method by; (1) coating on the surface of the contact part by the addition foods as liquid, and (2) solidify the liquefied addition foods.

Because a liquefied seasoning etc. are solidified by eating tools according to this invention, addition foods paste a contact part more certainly. Therefore, other things can be stopped from being soiled by addition foods before use or in use. Because addition foods are solidified by heating or dryness, eating tools can also be sterilized and preserved from decay, and it will be sanitary.

Other inventions are A manufacturing apparatus of an eating tools used for drinking or eating food comprising, a contact part for holding food and touching in a user's mouth, an addition foods part adhered or applied addition foods which contain either seasoning, food, medicines or a nutrients in the contact part, wherein the manufacture apparatus comprising; an attaching part holding an edge of the eating tools so as to position the contact portion downward, a round unit caring the attaching part, a rotation unit turning the eating tools held by the attaching part up to outside, an adhesion material service unit located along with a rotation course of the attaching part, coating to the contact portion an adhesion material which has adhesiveness when the eating tools rotate outside, an addition foods service unit located along with a rotation course of the attaching part, and an addition foods service unit adhering the granular or powdered addition foods to the contact portion by the adhesion material at the contact portion when the eating tools rotate outside, a heater located along with a rotation course of the attaching part, and heating or drying the eating tools in a rotation course.

Other inventions are A manufacturing apparatus of an eating tools used for drinking or eating food comprising, a contact part for holding food and touching in a user's mouth, an addition foods part adhered or applied addition foods which contain either seasoning, food, medicines or a nutrients in the contact part, wherein the manufacture apparatus comprising; an attaching part holding an edge of the eating tools so as to position the contact portion downward, a round unit caning the attaching part, a rotation unit for turning the eating tools held by the attaching part up to outside, an addition foods service unit located along with a rotation course of the attaching part, and coating the liquefied addition foods to the contact portion at the contact portion when the eating tools rotate outside, a heater located along with a rotation course of the attaching part, and heating or drying the eating tools in a rotation course.

Because these inventions have an adhesion material service unit, an addition foods service unit, and a heater along with a rotation course, by rotating an attaching part holding eating tools, addition foods as a grain, powder, or a liquid can be automatically added to a contact part. As a result, working efficiency at the time of manufacture can progress, and eating tools of the present invention can be produced in large quantities. Because addition foods are automatically solidified by heating or dryness according to the present invention, eating tools under manufacture can also be sterilized and preserved from decay, and safety can be raised.

(Effect of the Invention)

According to this invention as the eating tools, without seasoning food directly, flavor can be changed easily and various flavors can be tasted. And in a medical field, in cases where intake, such as sugar and salt, is restricted, the present invention is used, the intake can be restricted certainly, and the dosage can be certainly prescribed for the patient.

On the other hand, according to the invention as manufacturing method and a manufacture apparatus of the eating tools, the eating tools of the present invention can be automatically produced in large quantities.

### BRIEF DESCRIPTION OF THE DRAWINGS

FIG. 1 is the top view and side view showing the composition of the eating tools in a 1st embodiment.

FIG. 2A is a perspective view showing a fork as an example of the eating tools in a 1st embodiment.

FIG. 2B is a perspective view showing the example of the variation of the eating tools in a 1st embodiment.

FIG. 3 is a flow chart figure showing the manufacturing method of the eating tools in a 1st embodiment.

FIG. 4 is a side view showing the composition of the eating tools in a 2nd embodiment.

FIG. 5 is a flow chart figure showing the manufacturing method of the eating tools in a 2nd embodiment.

FIG. 6 is an explanatory view showing the manufacture apparatus of the eating tools in an embodiment, (a) is a top view, (b) is a front view, and (c) is a side view.

FIG. 7 is a side view showing operation of the rotation unit in the embodiment.

FIG. 8 is a side view showing the composition and operation of the adhesion material service unit in the embodiment.

FIG. 9 is a top view showing the composition of the guide plate in an embodiment.

FIG. 10 is a side view showing the composition and operation of an addition foods service unit in an embodiment.

### DETAILED DESCRIPTION OF THE PREFERRED EMBODIMENTS

### 1st Embodiment

(Composition of the Eating Tools)

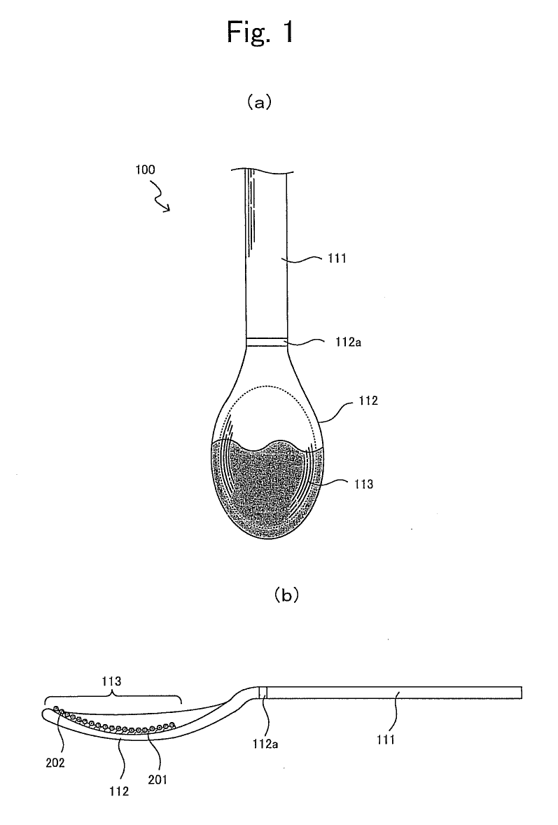

A 1st embodiment of the present invention will be explained with referring to the drawings. FIG. 1 (a) is a top view showing the composition of the eating tools in accordance with the present embodiment, and FIG. 1 (b) is a side view showing the composition of the eating tools in this embodiment. As shown in these figures, the eating tool in accordance with the present invention is a tool for eating food or drinking, and is described for an example as spoon 110 in this embodiment. Spoon 110 comprises handle 111 and a contact part 112.

Handle 111 is a part for handling by hand, in order that a user operates the spoon 110, is made from the material which has certain intensity, such as wood, a plastic, metal, or paper. And the edge of this handle 111 is the contact part 112.

The Contact part 112 is a part for holding food and touching in a user's mouth, and is shaped by the bowl of the usual spoon in the illustrated example. This contact part 112 is made from the material which has certain intensity, such as wood, a plastic, metal, or paper, like the handle 111. This contact part 112 is made from a material which has high adhesion with liquefied addition foods or adhesion material, as the material, the porous material like wood is suitable. In cases where a plastic or metal are chosen as the material, compatibility with addition foods or an adhesion material is raised by finishing the surface roughly or making up porosity. In this embodiment, the contact part 112 has a connecting part 112a, and is removable from the handle 111 of spoon 110.

And the addition foods part 113 is made in the contact part 112. This addition foods part 113 is made by adhering or coating the addition foods 202 which contain either a seasoning, food, a medicine or a nutrient on the contact part 112. The addition foods part 113 is inserted into a user's mouth with the food put on the contact part 112 at the time of eating or drinking. In particular, in this embodiment, as shown in FIG. 1 (b), the addition foods part 113 is made by coating adhesion material 201 to the surface of the contact part 112. The contact part 112 surfaces adhere to granular or powdered addition foods 202 by this adhesion material 201.

As addition foods 202, various seasonings, such as salt, sugar, various kinds of spices, a sweetener, a charge of acidity, and other various flavors, can be used. Real foods, such as cheese and cream, the other powdered food by freeze-dry, a medicine, a nutrient, etc. can be chosen as the addition foods 202.

In this embodiment, the processed food which mixed the egg white with gelatin is used as the adhesion material 201. Neither these addition foods 202 nor adhesion material 201 is limited to this embodiment. As addition foods 202, all constituents with flavor, a scent, a color, etc. can be used. As the adhesion material 201, all the viscous processed foods usable as food bonding agents, such as only an egg white or gelatin agar and carrageenan, can be used.

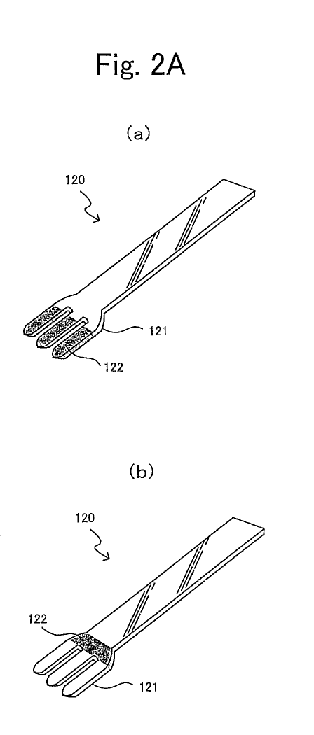

In this embodiment, even though it used the spoon for example of eating tools, but the present invention is not limited to this. As these eating tool, every tools for eating and drinking can be chosen, for example, a fork, a knife, chopsticks and a plate, a bowl, and a container like a glass are contained. FIGS. 2A and B are the perspective views showing other examples of eating tool.

As shown in FIG. 2A, in using a fork as eating tool, edge part 121 of the fork 120 becomes addition foods part 122 (the figure (a)), or the upper part of the edge part 121 becomes an addition foods part 122 (the figure (b)). As shown in FIG. 2B, in cases where knife 130 is used as the eating tool, the addition foods part 132 is made up on an edge 131 of knife 130 (the figure (a)), in cases where chopsticks 140 is used as the eating tool, the addition foods part 142 is made up on chopsticks end 141 as a contact part (the figure (b)). In cases where eating tool are containers like plate 150 as the eating tool, the addition foods part 152 is made up in upper edge part 151 as the contact part (the figure (c)). In this embodiment, even though a wood, metal, etc. were used for the eating tool, but the present invention is not limited to this. For example, the material which can be eaten like Cookie or a corn may be used as the eating tools.

(Manufacturing Method of Eating Tools)

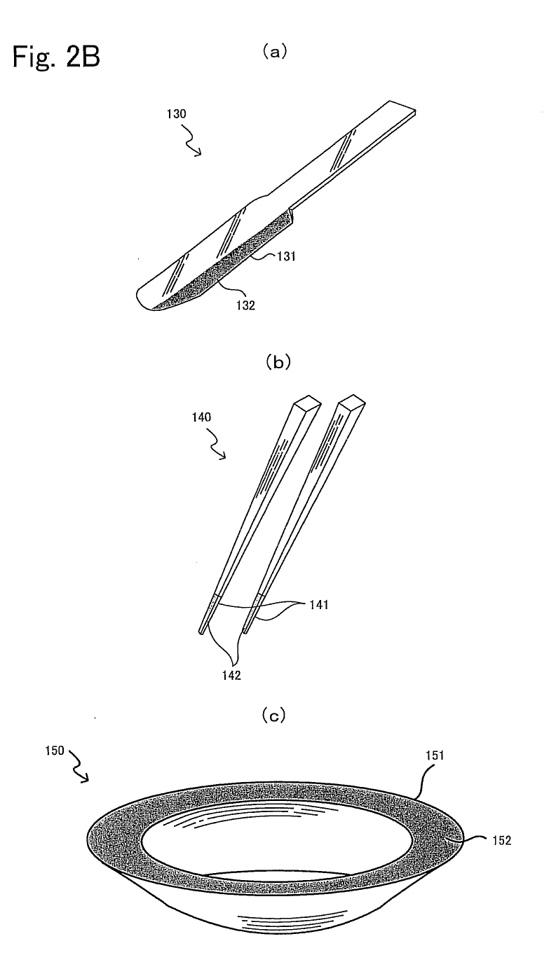

The eating tools explained above are made by the following steps. FIG. 3 is a flow chart shows the manufacturing method of the eating tools in this embodiment.

First, making the adhesion material 201 by mixing gelatin and an egg white (S101), if needed, heating the adhesion material 201 for mobility. Next, after the adhesion material 201 goes up to a certain temperature, the adhesion material 201 is coated to the contact part 112 (S102).

And in the situation where the adhesion material 201 was coated, dusting granular or powdered the addition foods 202 over the contact part 112, as a result, the surface of the contact part 112 adheres to the addition foods 202 by the adhesion material 201 (S103). Then, drying the gelatin as the adhesion material 201 until it turn to solidifies (S104). As this drying method, heating at 40° C.-80° C. in oven, sintering at 0° C.-300°C., depending on the kind and the characteristic of addition foods 203 or adhesion material 201, the combination of them, and relationship with food and drink, methods various for the dryness can be chosen suitably. As this dryness, drying by heating, wind power drying, natural seasoning, etc. can be used, and for the drying, mechanical drying means, such as a warm temperature apparatus and a motor fan, can be used. In order to solidify this adhesion material, the method of freezing by the freeze drying process by freezing, or refrigeration and quick-freezing, etc. (condensation) can be selected. And as the solidification processing, the method of solidifying the adhesion material with pressure can be used.

Then, the adhesion material 201 is dried, and when it is solidified, the addition foods 202 adhered to the adhesion material 201 are fixed. By this cause, the addition foods part 113 will be made up on the contact part 112 of spoon 110. The spoon 110 will be preserved from decay by drying, and it will be sanitary.

Meanwhile, some processes may be repeated if necessary. For example, the process for coating the liquefied adhesion material (S105), and the process for solidifying the adhesion material by natural seasoning or heating (S106), can be repeated. So, the addition foods part 113 is more certainly solidified on spoon 110.

(Composition of the Manufacture Apparatus of Eating Tools)

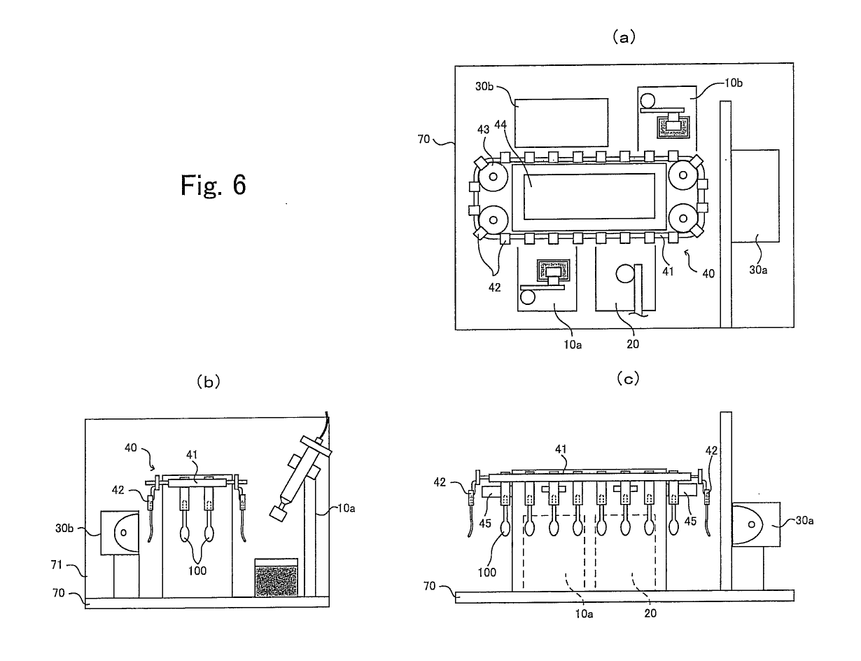

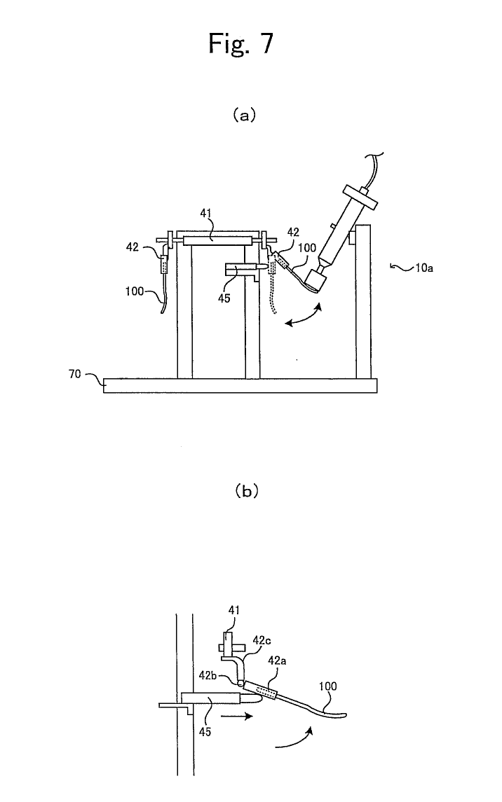

Next, the manufacture apparatus of the eating tools for enforcing the manufacturing method of the above eating tools will be explained. FIG. 6 (a)-(c) is a top view in an embodiment in which bending and showing the whole manufacture apparatus composition of eating tools 100, a front view, and a side view, FIG. 7 is a side view showing operation of the rotation unit in this embodiment.

FIG. 6 (a) Be shown in -(c), Manufacture apparatus 1 of the eating tools 100 in this embodiment is a apparatus which makes the eating tools 100, which has central apparatus 40, adhesion material service unit 10 (10a and 10b), addition foods service unit 20, and heating unit 30 (30a and 30b). These each part is constituted on the mount 70 like a working table.

The Mount 70 is a stand which fixes each part of the manufacture apparatus 1, is made from metal etc. A cover 71 is set on mount 70 from above, each part is covered by the cover 71 and each internal mechanism will be protected. And as for this embodiment, a central apparatus 40 is located in the center of the mount 70, around this, an adhesion material service unit 10 (10a and 10b), an addition foods service unit 20, and a heating unit 30 (30a and 30b) are arranged.

That is to say, in this embodiment, coating the contact part 112 with the adhesion material 201, in the situation, accreting the addition foods 202 to contact part 112, next, drying them by heating. The Eating tools 100 are completed by coating and drying the adhesion material 201 again. For following these processes, as for this apparatus, along with the rotation course, the adhesion material service unit 10a, the addition foods service unit 20, the heating unit 30a, the adhesion material service unit 10b, and the heating unit 30b are arranged in order around central apparatus 40.

The Central apparatus 40 is a power plant, which holds eating tools 100 and makes them go around the central apparatus 40, and in specified position, the eating tools 100 are rotated outside, and are shaken out. the Central apparatus 40 comprises surroundings actuator 41, a rotation unit 45, and a central controlling part 44.

The Surroundings actuator 41 is an endless belt which carries out surroundings motion of the attaching part, as shown in FIG. 6 (a), and is arranged at the upper part of central apparatus 40, hung on driving roller 43 arranged in the four corners of central apparatus 40, and rotates to the counterclockwise rotation in the figure. And as for this embodiment, many attaching parts 42 are hanging down from the surroundings actuator 41 with the constant space.

Attaching part 42 is a clip holding the upper edge of eating tools 100, and is hung to surroundings actuator 41, thereby the contact part 112 of eating tools 100 turns down. In this embodiment, the attaching parts 42 are made from metal etc., as shown in FIG. 7 (a) and (b), comprise a connecting part 42c connected with the surroundings actuator 41, and grasping part 42a rotatable hung to this connecting part 42c by a supporting spindle 42b. The Supporting spindle 42b has an elastic part like a spring, and maintains the position of suspension of the grasping part 42a by the elasticity usually.

And each attaching part 42 is grasping the upper edge of eating tools 100 by the elasticity of the grasping part 42a in the lower end part of grasping part 42a. As for embodiment, the Even though attaching part 42 holds eating tools by the elasticity of a spring, the present invention is not limited to this. All the materials which can hold eating tools 100 removable can be used, for example, as for it, adhesion material like a double-sided tape is also available.

The Rotation unit 45 are a driving means for rotating outside eating tools held by the attaching part 42, as for this embodiment, in the apparatus, they are arranged at the place which faced to the adhesion material service unit 10, the addition foods service unit 20, and the heating unit 30. The Rotation unit 45 pushes eating tools, and makes them swing outside with the definite timing.

Concretely, as shown in FIG. 7 (a), the Rotation unit 45 is arranged between the central controlling part 44 and the surroundings actuator 41, and has the mechanics expanded and contracted horizontally. As shown in FIG. 7 (b), when the rotation unit 45 expands towards outside, the attaching part 42 is pushed outside and the grasping part 42a is swung centering on the supporting spindle 42b supported by the surroundings actuator 41. The Eating tools 100 held at the attaching part 42 rotate towards outside by this cause, and the contact part 112 of the eating tools 100 is pushed out outside. When the rotation unit 45 shrinks, the pressure to the attaching part 42 disappears, the grasping part 42a is turned downward by the elasticity of the supporting spindle 42b, and gets back to a suspension position again.

The Central controlling part 44 is a controller which controls the drive of each part in the manufacture apparatus 1 of eating tools, has a regulating function for the speed of a surroundings actuator, and a regulating function of the rotation timing by a rotation unit. The Central controlling part 44 is connected also with the adhesion material service unit 10, the addition foods service unit 20, and the heating unit 30, adjusts the amount of applications by each part, a spray volume, heating quantity, etc.

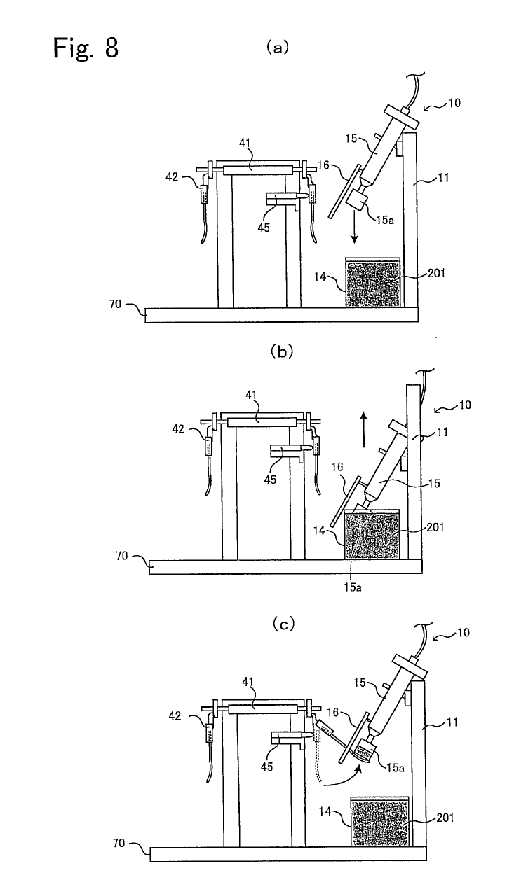

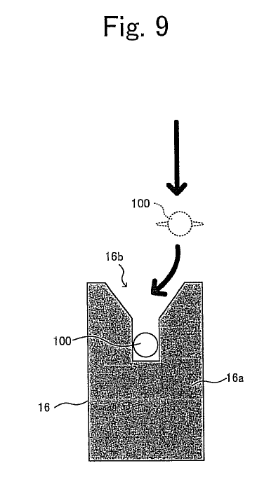

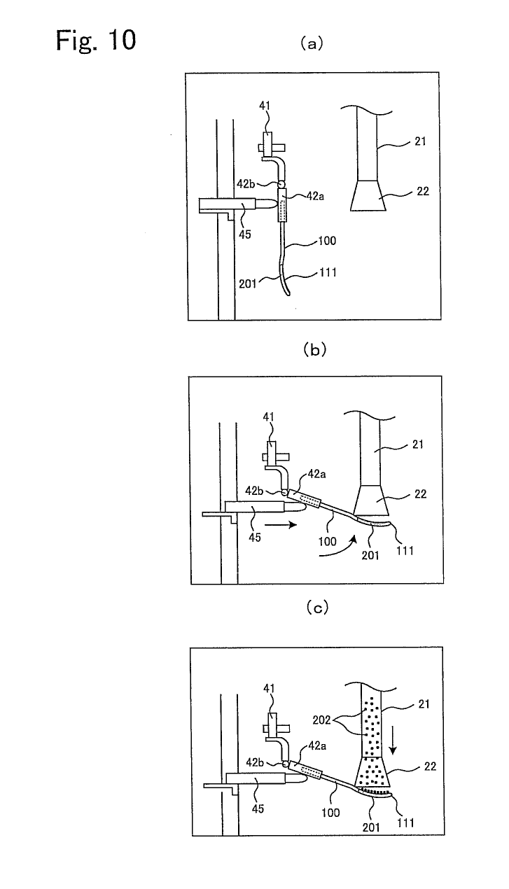

Next, the adhesion material service unit 10 (10a and 10b) arranged along with the rotation course of the attaching part 42, the addition foods service unit 20, and the heating unit 30 (30a and 30b) will be explained. FIG. 8 is a side view showing the composition and operation of adhesion material service unit 10 in this embodiment, FIG. 9 is a top view showing the composition of the guide plate in this embodiment, FIG. 10 is a side view showing the composition and operation in addition foods service unit 20 in this embodiment.

The Adhesion material service unit 10 (10a and 10b) are arranged along with the rotation course of the attaching part 42, when eating tools 100 rotate outside, coats the contact part 112 of eating tools 100 with the adhesion material 201. In this embodiment, as shown in FIG. 8, the adhesion material service unit 10 has a supporter 11 stood to mount 70, a Moving section 15 which it is combined with supporter 11 and slid up and down, an Adhesion material storage 14 which is located under the moving section 15 and stores adhesion material 201. The Adhesion material service unit 10 puts the adhesion material 201 to the contact part 112 of eating tools 100 by moving section 15, when the moving section 15 slides up and down centering on the supporter 11.

First, as shown in FIG. 8 (a), while the eating tools 100 are going around, the moving section 15 is slid downward from a top. Here, in this embodiment, a tip part 15a made from the material wet with a viscous liquid like sponge, cloth, and paper is attached to the top of the moving section 15. Adhesion material service unit 10 moves the moving section 15 below, dips the tip part 15a into the adhesion material 201 in the adhesion material storage 14, thereby the adhesion material 201 is infiltrated into tip part 15a. After predetermined time, as shown in FIG. 8 (b), the moving section 15 is slid to the upper part from the lower part of the supporter 11, and stops in a proper position. And as shown in FIG. 8 (c), when the rotation unit 45 rotates eating tools 100 outside, the tip part 15a is touched to the contact part 112, and the adhesion material 201 of the tip part 15a is put to the contact part 112.

In this embodiment, the guide plate 16 for moving the contact part 112 to the contact position of the tip part 15a is attached to the moving section 15. This guide plate 16 has a tabular support plate 16a as a base, as shown in FIG. 9, a Penetrated slit part 16b in Y form is made in the central apparatus 40 side of this support plate 16a. By this cause, when the eating tools 100 rotate, the handle of the eating tools 100 is inserted in this slit part 16b, the contact part 112 is moved to the position in contact with the tip part 15a.

The addition foods service unit 20 is a apparatus located along with the rotation course of the attaching part 42, when the eating tools 100 rotate outside, granular or powdered addition foods 202 are made to adhere to the contact part 112 of the eating tools 100 by the adhesion material 201.

In detail, the addition foods service unit 20 has a cylindrical feed section 21 which has a downward feed opening 22, as shown in FIG. 10 (a), the Addition foods service unit 20 is connected with the storage tank for accumulating addition foods (not shown) by the tube. A storage tank stores granular or powdered addition foods 202. the addition foods 202 are sent out to the feed section 21 from this tank. And in this embodiment, the addition foods service unit 20 supplies the addition foods 202 by the feed section 21 from a storage tank, when eating tools 100 rotate and the contact part 112 is positioned under the feed section 21, as shown in FIG. 10 (b) and (c). As a result, the contact part 112 adheres to the addition foods 202. The contact part 112 detects the position of the feed section 21 by the sensor of the feed section 21, for example, when the sensor detects the contact part 112, addition foods 202 are supplied. According to the period which eating tools 100 rotate, addition foods 202 are supplied for every interval without a sensor.

After adhering to addition foods 202 in the lower part of feed section 21, the eating tools 100 are returned to a suspension position. Change into this suspension position occurs by the elasticity of supporting spindle 42b, excessive addition foods 202 adhering to contact part 112 will be shaken off by shock of the downswing.

The Heating unit 30 (30a and 30b) are a apparatus is located along with the to rotation course of the attaching part 42, and heats or dries the contact part 112 of the eating tools 100 in motion. In this embodiment, the heating unit 30 comprises an electric heater, as for this, for example, every heat sources, such as an infrared lamp, an ultraviolet-rays lamp, a halogen lamp, can be used. And a wind generator, such as a motor fan, may be added to the heating unit 30.

And the heating units 30a and 30b are each located behind the adhesion material service units 10a and 10b in the rotation course, as shown in FIG. 6 (a) and (c).

As this drying method, heating at 40-80 in oven, sintering at 0-300, depending on the kind and the characteristic of addition foods 203 or adhesion material 201, the combination of them, and relationship with food and drink, methods various for the dryness can be chosen suitably. As this dryness, drying by heating, wind power drying, natural seasoning, etc. can be used, and for the drying, mechanical drying means, such as a warm temperature apparatus and a motor fan, can be used.

(An Operation and an Effect)

According to this embodiment, the contact part 112 of spoon 110 which touches in a user's mouth adheres to the addition foods 202 previously, and thereby the user does not need to mix a seasoning, and he has a favorite taste eaten, without doing complicated operations. Since the addition foods 202 do not mix in the food which does not touch spoon 110, when using the eating tools of different flavor, the user can taste various flavors with the same goods.

In this embodiment, granular or powdered addition foods 202 are being fixed by adhesion material 201 in addition foods part 113, as a result, addition foods 202 paste contact part 112 more certainly, and addition foods 202 do not peel off from the contact part 112 of the spoon while in use before use. In cases where salt is used as addition foods 202, the contact part 112 will be sterilized with salt and it will become sanitary. Since contact parts 112 and 122,132,142,152 of the eating tools are removable From other parts (for example, handle), users can taste other flavors easily by exchanging to the contact part 112 of other flavors, and thereby a parts other than addition foods 202 can be recycled, and it becomes economical. In the above embodiment, the contact part 112 can be made from wood or thermoplastic resin. In this case, because addition foods 202 can be adhered or coated to usual tableware in a market, the present invention can be used for existing goods. By rotating an attaching part holding eating tools 100, addition foods 202 as a grain, powder, or a liquid can be automatically added to the contact part 112, and thereby working efficiency at the time of manufacture can progress, and eating tools 100 can be produced in large quantities. Because addition foods 202 are automatically solidified by heating or dryness, eating tools 100 under manufacture can also be sterilized and preserved from decay, and safety can be raised. In particular, as for the manufacture apparatus in this embodiment, the simple mechanism and operation of changing grasping part 42a from drooping state voice to a rotation situation perform automatically the application of adhesion material 201, service of addition foods 202, and drying and sintering. As a result, the eating tools of the present invention can be made efficiently, avoiding complication and enlargement of an apparatus.

### (2nd Embodiment)

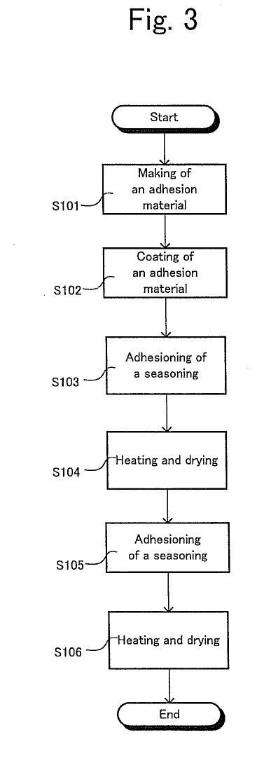

Even though granular or powdered addition foods 202 were used in the embodiment mentioned above, the present invention is not limited to these, for example, liquefied addition foods may be used. The embodiment which uses liquefied addition foods for below will be explained. FIG. 4 is a side view showing the eating tools concerning this embodiment. In this 2nd embodiment, in cases where it gives the same numerals to the same component as a 1st embodiment and does not make reference in particular, the function is the same and the explanation is omitted.

The foods part 113 is the part which made addition foods adhere to the contact part 112 directly, The addition foods part 113 is made by putting or impregnating with liquefied addition foods 203, and solidifying it. In this embodiment, as shown in FIG. 4, the addition foods part 113 is made by putting and solidifying liquefied addition foods 203 on the surface of the contact part 112.

Here, the liquefied seasoning which mixed gelatin and various addition foods is used as liquefied addition foods 203. For example, the liquid which melted water-soluble foods, such as salt, sugar, a flavor, in catalysts, such as water, an egg white, gelatin, can be used as these liquefied addition foods. As liquefied addition foods, the liquid which melted fluid foods, such as cheese, cream, a caramel, or a medicine and a nutrient in the catalyst of water etc. can be used.

Also in this embodiment, as this dryness, drying by heating, wind power drying, natural seasoning, etc. can be used, and for the drying, mechanical drying means, such as a warm temperature apparatus and a motor fan, can be used. In order to solidify these liquefied addition foods 203, the method frozen by the freeze drying process by freezing, or refrigeration and quick-freezing, etc. (condensation) can be selected. And as the solidification processing, the method of solidifying liquefied addition foods with pressure can be used.

This contact part 112 is made from the material which has certain intensity, such as wood, a plastic and metal, and a paper material. This contact part 112 is made from a material with high adhesion with liquefied addition foods 203 and adhesion material, as the material, the porous material of wood etc. is suitable. In cases where a plastic and metal are chosen as the material, compatibility with addition foods or an adhesion material is raised by finishing the surface roughly or making up porosity. In cases where contact part 112 is a porous material like wood, the addition foods part 113 soaks wooden contact parts 112 in liquefied addition foods 203, and solidifies addition foods 203.

(Manufacturing Method of Eating Tools)

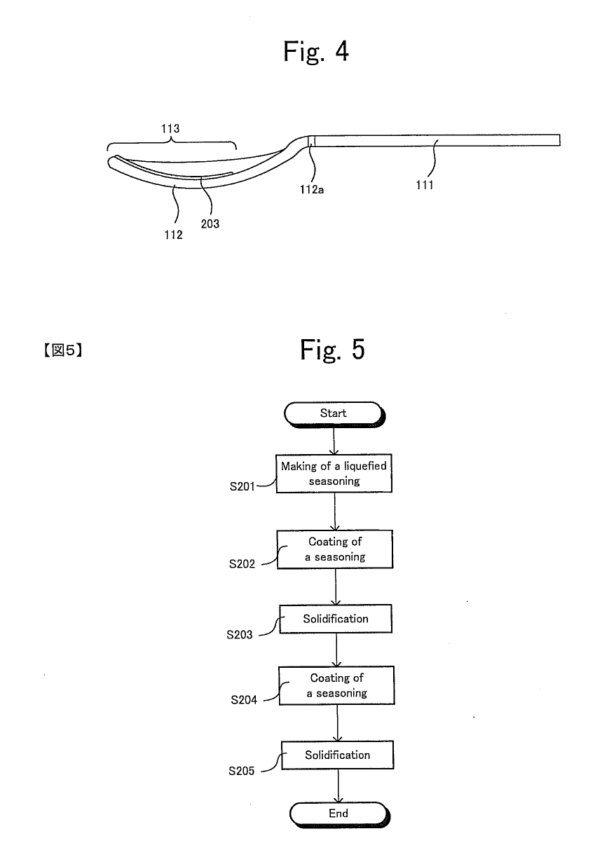

The above eating tools are made by the following steps. FIG. 5 is a flow chart which shows the manufacturing method of the eating tools in this embodiment.

First, mixing gelatin and the solution which dissolved various addition foods in water, heating it at constant temperature, and liquefied addition foods 203 are made (S201). And liquefied addition foods 203 are put to contact part 112 as a part of spoon 110 (S202).

Next, in the situation that addition foods 203 were put, addition foods 203 are solidified by natural seasoning or heat treatment (S203). By this cause, the addition foods part 113 is made on contact part 112 of spoon 110.

As this drying method, heating at 40-80 in oven, sintering at 0-300, depending on the kind and the characteristic of addition foods 203 or adhesion material 201, the combination of them, and relationship with food and drink, methods various for the dryness can be chosen suitably. As this dryness, drying by heating, wind power drying, natural seasoning, etc. can be used, and for the drying, mechanical drying means, such as a warm temperature apparatus and a motor fan, can be used.

Some processes may be repeated if necessary.

For example, in this embodiment, the process for coating the liquefied addition foods 203 (S204), and the process for solidifying the addition foods 203 by natural seasoning or heating (S205), are repeated. So, the addition foods part 113 is more certainly solidified on spoon 110.

(Manufacture Apparatus of Eating Tools)

Next, the manufacture apparatus of the eating tools for enforcing the manufacturing method of the above eating tools is explained. Also in this embodiment, the manufacture apparatus explained as a 1st embodiment can be used.

Liquefied addition foods are put and solidified in the manufacturing method of this embodiment. Therefore, by adhesion material service unit 10 (10a and 10b) of the above manufacture apparatus, liquefied addition foods are put, this is skipped, without operating addition foods service unit 20, and it solidifies by heating unit 30 (30a and 30b) immediately (sintering).

In detail, in this embodiment, liquefied addition foods 203 are stored to adhesion material service unit 10, and when eating tools 100 rotate outside, these liquefied addition foods 203 are put. In this embodiment, in order to make liquefied addition foods 203 put, the apparatus which puts addition foods 202 was used. But the present invention is not limited in this way, for example, the apparatus which can spray liquefied addition foods 203 on contact part 112 can also be used.

(An Operation and an Effect)

Because an addition foods 203 are solidified by eating tools, addition foods 203 paste a contact part 112 more certainly. Therefore, other things can be stopped from being soiled by addition foods 203 before use or in use. Because addition foods 203 are solidified by heating or dryness, eating tools can also be sterilized and preserved from decay, and it is sanitary.

By rotating an attaching part holding eating tools 100, addition foods 203 as a grain, powder, or a liquid can be automatically added to a contact part 112. As a result, working efficiency at the time of manufacture can progress, and eating tools 100 can be produced in large quantities. In particular, in the manufacture apparatus in this embodiment, the simple mechanism and operation of changing grasping part 42a from drooping state voice to a rotation situation perform automatically application of addition foods 203, and drying/sintering processing. As a result, the eating tools of the present invention can be made efficiently, avoiding complication and enlargement of an apparatus.

What is claimed is:

1. Eating tools for drinking or eating food comprising:
a contact part for holding food and touching in a user's mouth,
an additional foods part adhered or applied additional foods which contain either seasoning, food, medicines or a nutrients in the contact part.

2. The eating tools as claimed in claim 1, wherein the additional foods part is made up by;
coating on the surface of the contact part by a bonding material which has adhesiveness, and
putting the additional foods as granular or powdered on the contact part.

3. The eating tools as claimed in claim 1, wherein the additional foods part is made up by;
coating on the surface of the contact part by the additional foods as liquid, and
solidify the liquefied additional foods.

4. A manufacturing method of eating tools used for drinking or eating food comprising:
a contact part for holding food and touching in a user's mouth,
an additional foods part adhered or applied addition foods which contain either seasoning, food, medicines or a nutrients in the contact part, wherein the method further comprises;
coating on the surface of the contact part by a bonding material which has adhesiveness, and
putting the addition foods as granular or powdered on the contact part.

5. A manufacturing method of eating tools used for drinking or eating food comprising:
contact part for holding food and touching in a user's mouth,
an additional foods part adhered or applied additional foods which contain either seasoning, food, medicines or a nutrients in the contact part, wherein the method further comprises;
coating on the surface of the contact part by the addition foods as liquid, and
solidify the liquefied addition foods.

6. A manufacturing apparatus of eating tools used for drinking or eating food comprising:
a contact part for holding food and touching in a user's mouth,
an additional foods part adhered or applied additional foods which contain either seasoning, food, medicines or a nutrients in the contact part, wherein the manufacture apparatus further comprising;
an attaching part holding an edge of the eating tools so as to position the contact portion downward,
a round unit carrying the attaching part,
a rotation unit turning the eating tools held by the attaching part up to outside,
an adhesion material service unit located along with a rotation course of the attaching part, coating to the contact portion an adhesion material which has adhesiveness when the eating tools rotate outside,
an additional foods service unit located along with a rotation course of the attaching part, and an additional foods service unit adhering the granular or powdered addition foods to the contact portion by the adhesion material at the contact portion when the eating tools rotate outside,
a heater located along with a rotation course of the attaching part, and heating or drying the eating tools in a rotation course.

7. A manufacturing apparatus of an eating tools used for drinking or eating food comprising:
a contact part for holding food and touching in a user's mouth,
an additional foods part adhered or applied additional foods which contain either seasoning, food, medicines or a nutrients in the contact part, wherein the manufacture apparatus further comprising;
an attaching part holding an edge of the eating tools so as to position the contact portion downward,
a round unit carrying the attaching part,
a rotation unit for turning the eating tools held by the attaching part up to outside,
an additional foods service unit located along with a rotation course of the attaching part, and coating the liquefied additional foods to the contact portion at the contact portion when the eating tools rotate outside,
a heater located along with a rotation course of the attaching part, and heating or drying the eating tools in a rotation course.
